(19) United States
(12) Patent Application Publication
(10) Pub. No.: US 2024/0039948 A1
(43) Pub. Date: Feb. 1, 2024

(54) MAIL PROTECTION SYSTEM

(71) Applicant: DIATTACK YAZILIM BILISIM SIBER GUVENLIK VE DANISMANLIK ANONIM SIRKETI, Istanbul (TR)

(72) Inventors: Ali Aydin KOC, Istanbul (TR); Osman Bahri VARGELOGLU, Istanbul (TR); Sercan OKUR, Istanbul (TR)

(73) Assignee: DIATTACK YAZILIM BILISIM SIBER GUVENLIK VE DANISMANLIK ANONIM SIRKETI, Istanbul (TR)

(21) Appl. No.: 18/268,608

(22) PCT Filed: May 20, 2021
(86) PCT No.: PCT/TR2021/050471

§ 371 Date: Jun. 21, 2023

(30) Foreign Application Priority Data
Dec. 31, 2020 (TR) 2020/22866

(51) Int. Cl. H04L 9/40; G06F 40/205; H04L 51/212; G06F 40/30; H04L 51/214

(52) U.S. Cl. CPC H04L 63/1433; G06F 40/205; H04L 51/212; G06F 40/30; H04L 63/1483; H04L 51/214

(57) ABSTRACT

A computer-based mail protection system is configured for providing detection and prevention of malware and phishing attacks and provided between a first e-mail server and a second e-mail server in order to send an e-mail from the first e-mail server of a first client device to the second e-mail server of a second client device.

### CROSS REFERENCE TO THE RELATED APPLICATIONS

This application is the national phase entry of International Application No. PCT/TR2021/050471, filed on May 20, 2021, which is based upon and claims priority to Turkish Patent Application No. 2020/22866, filed on Dec. 31, 2020, the entire contents of which are incorporated herein by reference.

### TECHNICAL FIELD

The present invention relates to a computer-based mail protection system designed with an innovative architecture for providing detection of malware and phishing attacks made through an e-mail coming to an organization and/or to a company in a manner affecting the assets of said organization and/or said company.

### BACKGROUND

Phishing attacks are the most frequent exploitation method developed based on accessing essential information like identity information, credit card, etc. and obtaining various illegal rights on the information assets of victims by guiding victims to fake internet pages or by injecting malware by means of clicking of users on files and/or URLs which exist in the coming misleading e-mails sent to the e-mail addresses of victims, where said victims are predetermined or randomly selected target companies and persons. Phishing attacks are built on formation of field names which are similar to the field names of official web sites and on injection of malware to the user systems as users' carelessness ignores this or on detecting and exploiting the user browsers' gaps.

Today, the success ratio of the precautions, taken against malware and against the URLs used in phishing attacks, is low as seen from the faced attacks. Since the phishing URLs imitate the target organizations and brands, the phishing attack becomes successful at the first instant where the URL is clicked. The solutions against the present phishing URLs are Blacklist-based. As URL is detected, it is added to the Blacklist. The method, used in the National Cyber Events Intervention Center which exists in our country and used in sites like PhishTank, Phishstat which exist in the world, detects phishing URLs based on Blacklist and publishes the harmful URLs on the site. By means of this method, newly formed phishing URLs cannot be detected or the active phishing sites which have not yet been detected cannot be detected. In traditional methods, there is no system which pre-estimates phishing URLs and harmful internet sites. Advancing by means of traditional methods is insufficient for preventing phishing attacks.

When the economical damage given by the phishing attacks is examined, it is seen that the monetary loss proportion as mentioned in the reports is high. One of said proportions is seen in the 2018 Internet Crime Report of FBI where the work e-mail safety infringement is not theoretical. In said report, it is mentioned that the monetary losses which result from work e-mail safety infringement has increased by 427% to 1.3 billion US dollars since 2015. It has been detected that 54% of the data infringements occurs since the employees click on suspicious e-mails and web sites. Associated Press, which is a news agency centered at United States of America, has notified that Mattel, which is a toy producer, has lost 3 million dollars in 2015 by means of the phishing mail formed as if CEO of Mattel has sent said e-mail. In 2015, Ubiquiti, which is a technology company, has explained in its three months financial report that it has loss of 46.7 million dollars due to a phishing mail.

In the STM-Cyber Threat Report—April-June 2020 report where the cyber attacks faced in our country are examined, the phishing attacks realized within the latest six months in Turkey have been examined and information has been given related to the targets of the attacks and which platforms the attacks are executed and the analyses made. It has been detected that the target of the attacks is our citizens and that the imitations of the e-trade, e-government and banking web sites are formed within this scope, and attacks are planned/realized by means of these.

When the events faced both in the world and in our country are examined, the damages faced or which may be faced and the threats of the phishing attacks are seen. The detection of malware, used in attacks, by antivirus products can provide a protection with a low proportion where using antivirus products is one of the traditional methods. It is evaluated that the reason thereof is the obfuscation, anti-decompilation and sandbox evasion methods used for instance in “jar” file of the harmful files. The operational rationale of the present anti-viruses is focused on formation of signature-based information list about the harmful files. Static and dynamic analyses are made in relation to the harmful file by the analysts of antivirus companies, and file information is deducted. Since the databases of antivirus are not updated and are not rapid, malware cannot be caught. The traditional methods used in the present art cannot provide sufficient level of protection against phishing attacks and malware. New systems are needed for decreasing the monetary loss which increases every passing day.

As a result, because of the abovementioned problems, an improvement is required in the related technical field.

### SUMMARY

The present invention relates to a mail protection system, for eliminating the abovementioned disadvantages and for bringing new advantages to the related technical field.

An object of the present invention is to provide a mail protection system for providing detection of phishing attacks and malware made through an e-mail coming to an organization and/or to a company.

In order to realize the abovementioned objects and the objects which are to be deducted from the detailed description below, the present invention relates to a computer-based mail protection system for providing detection and prevention of malware and phishing attacks and provided between a first e-mail server and a second e-mail server in order to send an e-mail from said first e-mail server of a first client device to said second e-mail server of a second client device. Accordingly, the improvement is that the subject matter computer-based mail protection system comprises a processor unit embodied to realize computer-based commands and a memory unit associated with said processor unit and wherein the pre-detected data is stored, the processor unit is configured to realize the steps of:
Providing receiving of the e-mail coming from the first e-mail server,
Providing reading of the mail content of the e-mail and the appendices taken from the first e-mail server,
Providing parsing of the read mail content into parts like heading, body and appendices,
Providing detection of the URLs provided in the body and the files provided in the appendices in the mail content separated to parts,
Providing controlling whether the detected URLs and/or files are recorded in the pre-recorded blacklist and whitelist,
Determining that the mail is harmful and preventing transferring the mail to the first e-mail server by taking the mail to quarantine in case it is detected that at least one of the URLs and/or files is recorded in the blacklist and whitelist,
Providing formation of at least one artificial intelligence model by using artificial intelligence and machine learning algorithms of URLs and/or files in case it is detected that URLs and/or files are not recorded in the blacklist and whitelist,
Providing detection of the characteristics of URLs and/or files,
Providing inputting of the detected URL and/or file characteristics to the formed artificial intelligence model,
Providing formation of a score value according to the analytical risk conditions for the URLs and/or files from the artificial intelligence model,
Detecting whether the software is harmful or harmless according to the formed score value,
Providing taking the e-mail, comprising malware, to quarantine,
Providing recording of the URLs and/or files, taken to quarantine, to the whitelists and blacklists,
Providing transferring of the e-mail, comprising harmless software, to the second e-mail server.

Thus, by means of the mail protection system, the malware and/or phishing attacks existing in e-mails sent between the first client and the second client can be detected and the harmful URL and/or files can be prevented.

In a possible embodiment of the present invention, a communication unit is provided which provides communication between the processor unit and the first e-mail server and the second e-mail server.

In another possible embodiment of the present invention, the processor unit is configured to provide detecting of fake links by means of image processing from the coming mails, detecting the similarities by means of content text processing and realizing sentiment analysis and providing protection against the fake local sites and providing analytical risk scoring.

In another possible embodiment of the present invention, the processor unit is configured to provide presenting of the determined characteristics, which are in relation to the e-mail content, in the form of a report, which comprises visual graphics, to the device of the second client in order to provide informing of the second client. Thus, the user will be informed by means of visual graphics.

In another possible embodiment of the present invention, the first e-mail server comprises the identity authentication unit and the integrated security unit.

In another possible embodiment of the present invention, the identity authentication unit is configured to provide realization of the identity authentication process of the mail by providing DMARC application, reporting and analysis.

In another possible embodiment of the present invention, the integrated security unit is configured to provide examining of the internal and external mails.

### BRIEF DESCRIPTION OF THE DRAWINGS

FIG. 1 shows a representative view of the operation scenario of the mail protection system.

FIG. 2 shows a representative view of the mail protection system.

### REFERENCE NUMBERS IN THE FIGURES

10 Mail protection system
100 Processor unit
200 Memory unit
210 Regulation module
220 Content parsing module
230 Queue analysis module
240 Safety module
250 Analytical module
251 Brand protection unit
252 Sandbox unit
253 Artificial intelligence based malware detection unit
254 Artificial intelligence based URL detection unit
260 Result module
270 Quarantine module
300 Communication unit
20 First client
400 First e-mail server
410 Identity authentication unit
420 Integrated security unit
30 Second client
500 Second e-mail server

### DETAILED DESCRIPTION OF THE EMBODIMENTS

In this detailed description, the subject matter is explained with references to examples without forming any restrictive effect only in order to make the subject more understandable.

The present invention relates to a computer-based mail protection system (10) designed with an innovative architecture for providing detection of malware and phishing attacks made through an e-mail coming to an organization and/or to a company in a manner affecting the assets of said organization and/or said company.

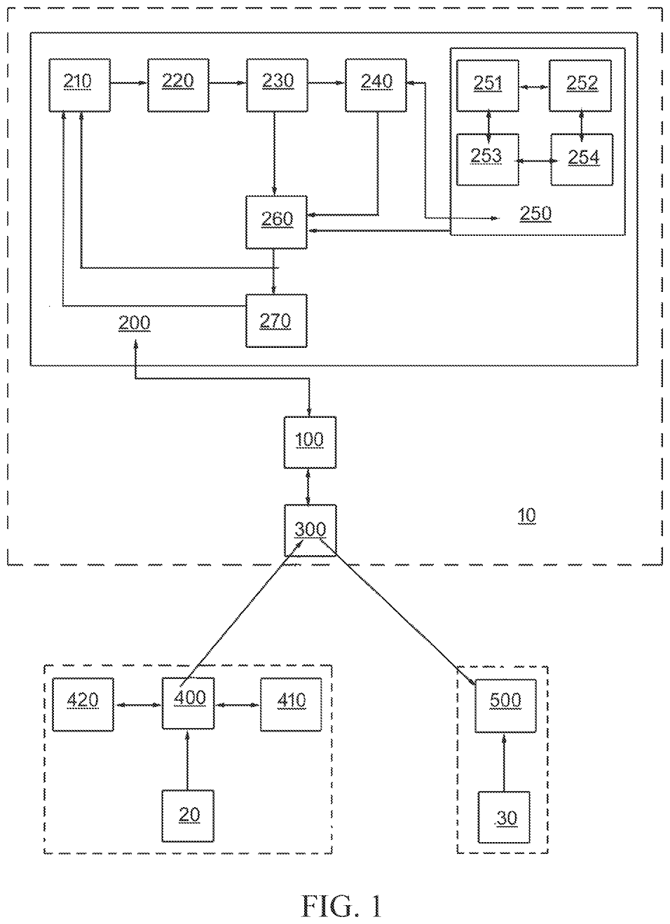

With reference to FIG. 1, said mail protection system (10) provides detection of malware and phishing attacks made through an e-mail sent from said first e-mail server (400) to said second e-mail server (500) and provided between a first e-mail server (400) of a first client (20) device and a second e-mail server (500) of a second client (30) device. The mail protection system comprises a processor unit (100) embodied to provide reading of the computer-based software providing operation of the subject matter and realization of the read software commands. There is a memory unit (200), which stores said computer-based software, associated with said processor unit (100). There is a communication unit (300) configured to provide data exchange between the processor unit (100) and the first e-mail server (400) and the second e-mail server (500). Said computer-based software comprises pluralities of functional software modules formed by pluralities of software commands. When the command lines of said software modules are read by the processor unit (100), the processes which provide analysis of the mail content are realized.

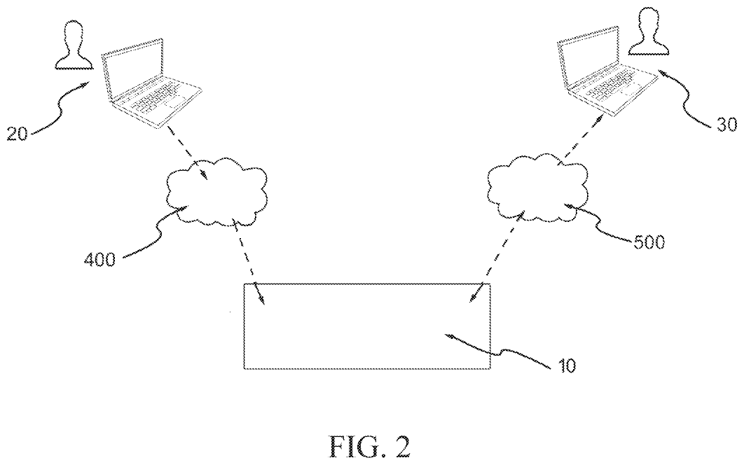

With reference to FIGS. 1 and 2, the e-mail sent from the first e-mail server (400) to the second e-mail server (500) is first of all controlled in an identity authentication unit (410) and in an integrated security unit (420). Said identity authentication unit (410) is configured to realize the functions of DMARC application, reporting and analysis for the coming mail. For the e-mail identity authentication technologies known as SPF (Sender Policy Framework) and DKIM (Domain Keys Identified Mail), said DMARC application comprises the policy layer. In order to confirm whether the mail comes from the correct location, Sender Policy Framework (SPF) is added as text record to the DNS records of the domain of the mail. The conditions where mail can be sent are determined through the field name inside the SPF record. DKIM record described as Domain Keys Identified Mail is the process of sending a part of a mail to the opposite party in an encrypted manner. The opposite party needs a key for opening said encrypted mail. Said key is taken from the DKIM record provided in the DNS record of the domain which sends the mail. After taking the key, the mail is decrypted, and it is checked whether the mail parts which are non-encrypted and encrypted are matching with each other or not. If the mail content matches with each other, DKIM control is evaluated as suitable and the mail is received in a successful manner. Said integrated security unit (420) is configured to provide examination of the internal or external mails. In the integrated security unit (420), a pre-control of the mails, transferred from the first e-mail server (400) to the second e-mail server (500) and/or from the second e-mail server (500) to the first e-mail server (400), is realized before entering the mail protection system (10) and/or while exiting the mail protection system (10). In a possible embodiment of the present invention, as the e-mail, transferred from the first e-mail server (400) to the second e-mail server (500), is controlled in the identity authentication unit (410), said e-mail passes through a gateway and is taken as an input to the mail protection system (10) before being transferred to the second e-mail server (500). Said gateway is named as firewall. The firewall provides controlling of all coming and going network traffic, and has been configured to provide realization of a pre-filtering process in accordance with predetermined rules against the harmful actions.

The processor unit provides analysis of the coming e-mail according to the computer commands written in the modules kept in the memory unit (200). The processor unit (100) first of all provides reading of the software commands which exist in a regulation module (210) provided to the memory unit (200). Said regulation module (210) comprises software commands which provide reading of the coming e-mail content and the appendices thereof. The regulation module (210) comprises an algorithm provided to be in integrated structure with the SMTP protocol which is the simple mail transfer protocol. The regulation module (210) is moreover configured to include command lines which will provide transfer of the e-mail to the second e-mail server (500) in case it is detected by the processor unit (100) that the coming e-mail is harmless. The regulation module (210) is the module where the process is realized which receives and reads the e-mail coming from the first e-mail server (400) and which moreover provides sending of the e-mail to the second e-mail server (500) after the e-mail is controlled by means of the processor unit (100). The processor unit (100) provides transfer of the e-mail content, read in the regulation module (210), to a content parsing module (220) for providing separation of said e-mail content into parts. Said content parsing module (220) comprises software commands embodied to provide examining of the e-mail content by separating the e-mail content into parts like heading, body and appendices. The processor unit (100) moreover provides detection of the URLs and/or files from the e-mail content separated into parts in the content parsing module (220). The detected URL and/or files is/are sent to a queue analysis module (230). Said queue analysis module is configured to include the command lines which will provide realization of the performance and capacity management for the URLs and/or files received from the content parsing module (220). The queue analysis module is embodied to include the safety rules for over-loading or most harmful attacks which impair the system balance by means of the queue structure formed in critical conditions. The queue analysis module provides realization of the sorting and prioritization process before the URLs and/or files, received in equal and close times, are entered into the analysis process. Depending on the sorting and prioritization process, the coming URL and/or files are taken to the queue for being examined in accordance with the capacity condition and URLs and/or files are singularized and sent for analysis. The same URLs and/or files, taken to the process order, are waited for the decision before being taken to the process order. In other words, the queue module prevents passing of the URLs and/or files, having the same content in the mail, through the same process repetitively, and provides protection of the system from over-loading or abnormal conditions. While the processor unit (100) realizes said software commands provided to the queue analysis module (230), it provides transfer of URLs and/or files, which are not taken to the queue, to a safety module (240) which is the next module and comprising a blacklist and a whitelist. It is waited that the analysis process of the URLs and/or files, taken to the queue, is realized. In case it is detected as a result of the analysis that the URL and/or files comprise(s) malware, a result data, including that the e-mail content comprises malware, is transferred to a result module (260).

With reference to FIGS. 1 and 2, in a possible embodiment of the present invention, said lists are known as Blacklist and Whitelist. Whitelist comprises internet networks where some internet networks are delimited by the network specialists of companies. In other words, the company employees have permission for access to the internet networks determined by means of Whitelist and do not have permission for access to the internet networks which remain outside of the list. Blacklist comprises internet networks comprising predetermined malware. In other words, Blacklist comprises the list of internet networks where there is no access permission for the company employees and which are known to be harmful. The processor unit (100) provides control of whether the URLs and/or files are in the safety module (240) or not. The safety module (240) comprises the software commands which provide scanning of the blacklists and whitelists. The processor unit (100) provides transfer of a result data, including that the URL and file include bad software, to the result module (260) in case it detects that any of the URL and/or the file is within the blacklist as a result of scanning. In case the processor unit (100) detects that all determined URLs and/or files are within the whitelist, it provides transfer of a result data, including the information indicating that the URL and/or the file is clean and openable, to the result module (260). In case none of the determined URLs and/or files is within the whitelist and blacklist, the commands which exist in the safety module (240) are completed by means of the processor unit (100), and passage to the analytical module (250) is provided.

With reference to FIGS. 1 and 2, the processor unit (100) provides realization of the command lines which provide control and analysis of the URLs and/or files which pass from the safety module (240) to the analytical module (250). The analytical module (250) comprises a brand protection unit (251), a sandbox unit (252), an artificial intelligence-based malware detection unit (253) and an artificial intelligence based phishing URL detection unit (254). Said brand protection unit (251) comprises command lines which will provide examination of the URLs by utilizing company domains for protecting systems of companies and/or brands. The processor unit (100) provides transfer of a result data, which includes the information indicating that the e-mail includes bad software, to the result module (260) in case it detects that any one of the URLs coming to the brand protection unit (251) is imitated. Said Sandbox unit comprises command lines which provide determination of the attributes of the files received from the safety unit and which provide transfer of the determined attributes to said artificial intelligence based malware detection unit. The artificial intelligence based malware detection unit is configured to include command lines which provide development of artificial intelligence models for the detection of attackers who embed the harmful code parts into the files added to the e-mail and who desire to realize phishing attack and which provide usage of the developed models for the analysis of the files taken from the Sandbox unit. The artificial intelligence based malware detection unit provides usage of machine learning and deep learning methods for the detection of attackers who desire to realize phishing attack by embedding the harmful code parts into the files added to the e-mail and provides development of artificial intelligence models. Said artificial intelligence models comprise mathematical models which will provide detection of whether the file is harmful or harmless as the file behaviors are given as input. The artificial intelligence based malware detection unit provides realization of both static and dynamic analysis of file coming from the safety unit. By means of the static analysis method, the files having extension of portable executable are analyzed and the characteristics thereof are determined. By means of the dynamic analysis method, the files with extensions DLL, SYS, EXE, CPL, PDF, DOC(X)(M), XLS(X)(M), PPT(X)(M), ELF, ZIP, 7z, JAR, TAR, BZIP, ISO, RAR, MSI are analyzed and the characteristics thereof are determined. As a result of static and dynamic analysis, the following characteristics are analyzed: the number of suspicious parts used in file heading, the number of URLs which exist in the file heading, the number of IP which exists in the file heading, the number of key words used for eluding antivirus and which exist in the file heading, the number of suspicious strings which exist in the file heading and the numbers of API calls sent from the file to the operation system and the graph (diagram) analysis of the points where said API calls touch. As a result of inputting the determined characteristics to the formed artificial intelligence model and/or models, a scoring is realized according to the analytic risk condition of the file. It is determined whether the file will be opened or not according to the determined score value. The processor unit (100) provides transfer of a result data, including whether the file is harmful or harmless, to the result module (260) according to the score value determined for the file.

With reference to FIGS. 1 and 2, the artificial intelligence-based phishing URL detection unit (254) comprises command lines which provide analysis according to the artificial intelligence model which provides determination of the characteristics of URLs coming from the safety unit and formed by using machine learning and deep learning methods beforehand. The artificial intelligence-based phishing URL detection unit (254) provides inputting of characteristics like domain length of the URLs, the number of characters, the similarity result calculated by means of image processing, the collected intelligence data and domain similarity scores to the artificial intelligence model and provides a scoring of the URL according to the analytical risk condition as a result of the model. The processor unit (100) provides realization of the commands which exist in the artificial intelligence based URL detection unit (254). The processor unit (100) provides transfer of a result data, including the information indicating that the URL is harmful or harmless, to the result module (260) according to the scope formed in the artificial intelligence based URL detection unit (254). The artificial intelligence based URL detection unit (254) moreover comprises command lines which provide taking of the screen image of the URLs and URL content coming from the safety unit and which provide the images to be processed by the image processing methods and analyzing of said images. Thus, the URL and the URL content are controlled separately.

The processor unit provides recording of URLs and/or files, detected in analytical module (250), to the blacklists which exist in the safety module (240). The processor unit (100) moreover provides recording of the harmless URL and/or files, detected in the analytical module (250), to the whitelist. Thus, the e-mails, including the same harmful or harmless software, are detected or defined without passing from the safety module (240) to the analytical module (250) in other e-mail controls to be realized afterwards. This facilitates reduction of the process steps in the e-mail controls to be realized afterwards.

The units provided in the analytical module comprise command lines embodied to provide realization of detection of fake link by means of image processing through the content of the coming URLs and/or files, similarity detection by means of content text processing and sentiment analysis (whether the mail content is positive, negative or neutral), analytical risk scoring, and strong protection against the attacks guided to the organization. For the detection of fake link, the measurement of text similarity related to the field name is used. Said measurement of text similarity is evaluated as a natural language processing study where the similarity between the texts is compared and where the content similarity of the texts are evaluated as a result of comparison. The text similarity studies are collected in two main classes, namely literary class and semantic class. The literary approaches comprise character array based approaches and the semantic approaches cover compile-based and information based methods. Character array based methods are based on the principle of measuring the similarity between the character-array and character array flows. The character array similarity criterion is the measuring of the similarity or the distance between the two character arrays. Damerau-Levenshtein and Jaro-Winkler method can be given as an example to the character-based methods. Damerau-Levenshtein provides calculation of the similarity between the two character arrays in terms of the minimum number of processes required for transforming one character array into the other character array. Jaro method provides calculation of the distance between the two character arrays through the number and order of the common characters. In the light of the text-similarity methods, new and dynamic structured similarity algorithm is developed for the similarity of the domains. Thus, the data is determined which will provide detection of phishing attacks which aim at the important companies, brands or applications existing in our country. Sentiment analysis is made in the mail text content and the sentiment class of the mail content is estimated. By means of estimation of the sentiment class, precaution is taken against the positive words and contents frequently used for facilitating deceiving of the users in phishing attack mails. While sentiment analysis is being made, the coming mails are tagged in specific data set manually, and term-frequency matrices are formed from the mail content after said tagging is made, and the classes, tagged by means of machine learning models, are estimated. By means of the feedbacks coming from the result module (260), the analytical module (250) has the re-learning structure which is renewed automatically. The patterns, obtained in the up-to-date state, are learned, and model updating is realized. In this case, adaptive learning is provided and model updating can continue.

With reference to FIG. 1, the processor unit (100) provides reading of the command lines which provide detection whether the mail is openable or non-openable according to URLs and file information comprising malware or harmless software coming to the result module (260). In the result module (260), the determination of the mails comprising harmful URL and/or file is provided. The e-mails, detected to be harmful or harmless, are sent to the quarantine module (270). The quarantine module (270) comprises command lines which provide blocking of the coming harmful e-mails and taking said e-mails to quarantine and which provide transfer of the coming harmless mails to the regulation module (210). The processor unit (100) provides prevention of the mails comprising harmful URL and/or file among the mails sent from the result module (260) to the quarantine module (270) and provides transfer of the mails, which do not comprise harmful URL and/or file, to the regulation module (210). The processor unit (100) provides transfer of the harmless mail, transferred to the regulation module (210), to the second e-mail server (500). The processor unit (100) is moreover configured to visually present a report, comprising the data related to the e-mail including malware, to the second e-mail server (500) by means of the regulation module (210). The report presented visually comprises information like the harmful e-mail content, harmful URLs and/or files, the score ratio of the malware, sentiment analysis ratio, etc. Thus, the user is informed about the content of the coming e-mail, and the conditions where the e-mail comes and why the e-mails are prevented, etc.

An exemplary operation scenario of the present invention is described below;

As shown in FIGS. 1 and 2, an e-mail is sent from a first company which has a first e-mail server (400) and to a second company which has a second e-mail server (500). First of all, the e-mail is formed from a first device which belongs to the first company having the first e-mail server (400). The mail, formed in the first device, is transferred to the first e-mail server (400). The mail passes through the firewall, which is the gateway, from the first e-mail server (400). The e-mail passing through the gateway is taken to the mail protection system (10) by means of the communication unit (300). In the mail protection system (10), the software commands provided in the modules provided to the memory unit (200) are read by means of the processor unit (100) and the process steps are realized. First of all, the content of the e-mail taken in the regulation module (210) is read. The read e-mail content is separated into parts like heading, body and appendices in the content parsing module (220). In the content parsing module (220), the URLs and/or files existing in the e-mail content separated into parts are detected. In the queue analysis module (230) of the detected URLs and/or files, the safety rules are analyzed for the multiple harmful attacks or over-loading which deteriorate system balance by means of the queue structure formed in critical conditions. As a result of the analysis made in the queue analysis module (230), a result data, including the malware information, is transferred to the result module (260) in case malware is faced. In the queue analysis module (230), as a result of the analysis made in URLs and/or files, in case malware is not faced, the URLs and/or files are transferred to the safety module (240) including the whitelist and the blacklist. In the safety module (240), it is checked whether the URLs and/or files are within the whitelist or the blacklist. In case at least one of the URLs and/or files exists in the blacklist, the result data, including the information indicating that the mail includes malware, is transferred to the result module (260). In case the URLs and/or files are in the whitelist, the result data, including the information indicating that the mail includes harmless software, is transferred to the result module (260). In case the URLs and/or files do not exist in the whitelist or blacklist, URLs and/or files are transferred to the analytical module (250). The analytical module (250) comprises four different units. One of said units is the brand protection unit (251). In the brand protection unit (251), the harmful URLs are detected by utilizing similarity algorithm in a manner preventing phishing attacks by imitating brands, organizations or companies provided in the coming URLs. In the Sandbox unit (252) which is a second unit, the files are analyzed and the characteristics of the files are determined. The determined characteristics are transferred as input to the artificial intelligence based malware detection unit. The artificial intelligence based malware detection unit provides analyzing of the file and provides scoring of the file according to the analytical risk condition according to the predetermined artificial intelligence models by means of the machine learning and deep learning algorithms. It is determined whether the file shall be opened or not according to the determined score value. The artificial intelligence based URL detection unit (254) which is a fourth module provides determination of the characteristics of the coming URLs. The URLs of which the characteristics are determined are analyzed according to the artificial intelligence model formed by pre-learned machine learning and deep learning algorithms. According to the result of the analysis, the URLs are scored according to the analytical risk condition. According to whether URLs and/or files include harmful or harmless software as a result of the processes made in the analytical module (250), recording to the whitelists and blacklists provided in the safety unit is provided. The data, which is related to URLs and/or files including malware or harmless software detected in the analytical module (250), is transferred to the result module (260). In the result module (260), the information whether the e-mail comprises malware or not is collected. In accordance with the result data collected in the result module (260), the information indicating that the e-mail is harmful or harmless is transferred to the quarantine module (270). The quarantine module (270) provides prevention by blocking the e-mail if the e-mail comprises malware. A report, including the data related to the blocked e-mail content, is transferred to the regulation module (210) in order to be sent to the second e-mail server (500). The report, coming to the regulation module (210), is transferred to the second e-mail server (500). A user, who uses the second device, is informed by means of graphics formed visually and indicating that the e-mail is prevented. The quarantine module (270) moreover provides transferring of the e-mail to the regulation module (210) if the e-mail does not include malware. The e-mail transferred to the regulation module (210) is transferred to the second e-mail server (500).

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

What is claimed is:

1. A computer-based mail protection system for providing detection and prevention of malware and phishing attacks and provided between a first e-mail server and a second e-mail server in order to send an e-mail from the first e-mail server of a first client device to the second e-mail server of a second client device, wherein the computer-based mail protection system comprises a processor unit embodied to realize computer-based commands and a memory unit associated with the processor unit and wherein pre-detected data is stored, the processor unit is configured to realize the steps of:
providing receiving of the e-mail coming from the first e-mail server,
providing reading of a mail content of the e-mail and appendices taken from the first e-mail server,
providing parsing of the mail content into parts like heading, body and appendices,
providing detection of URLs provided in the body and files provided in the appendices in the mail content separated to parts,
providing controlling whether the URLs and/or files are recorded in pre-recorded blacklists and whitelists,
determining that the mail is harmful and preventing transferring the mail to the first e-mail server by taking the mail to quarantine in case it is detected that at least one of the URLs and/or files is recorded in the blacklist and whitelist,
providing formation of at least one artificial intelligence model by using artificial intelligence and machine learning algorithms of URLs and/or files in case it is detected that URLs and/or files are not recorded in the blacklist and whitelist,
providing detection of characteristics of URLs and/or files,
providing inputting of the URL and/or file characteristics to the formed at least one artificial intelligence model,
providing detection of fake links by means of image processing through a content of the URLs and/or files,
providing making of sentiment analysis through the content of the URLs and/or files and providing estimation of a sentiment class,
providing examination of the URLs by utilizing similarity algorithms for detecting that brand and/or company domains are imitated,
providing formation of a score value according to analytical risk conditions for the URLs and/or files from the at least one artificial intelligence model,
detecting whether a software is harmful or harmless according to the score value,
providing taking the e-mail, comprising malware, to quarantine,
providing recording of the URLs and/or files, taken to quarantine, to the whitelists and blacklists,
providing, submission of a visual report, which includes data related to the imitated brand and company domains, the harmful e-mail content, harmful URLs and/or files, a score ratio of the malware and sentiment analysis, to the second e-mail server, and
providing transferring of the e-mail, comprising harmless software, to the second e-mail server.

2. The mail protection system according to claim 1, wherein a communication unit is configured to provide communication between the processor unit and the first e-mail server and the second e-mail server.

3. The mail protection system according to claim 1, wherein the processor unit is configured to provide detecting similarities by means of content text processing and realizing sentiment analysis and providing protection against fake local sites and providing analytical risk scoring.

4. The mail protection system according to claim 1, wherein the processor unit is configured to provide presenting of the determined characteristics, which are in relation to the e-mail content, in the form of a report, which comprises visual graphics, to the device of the second client in order to provide informing of the second client.

5. The mail protection system according to claim 1, wherein the first e-mail server comprises an identity authentication unit and an integrated security unit.

6. The mail protection system according to claim 1, wherein the identity authentication unit is configured to provide realization of an identity authentication process of the mail by providing DMARC application, reporting and analysis.

7. The mail protection system according to claim 1, wherein an integrated security unit is configured to provide examining of internal and external mails.
